(19) United States
(12) Patent Application Publication
(10) Pub. No.: US 2015/0208654 A1
(43) Pub. Date: Jul. 30, 2015

(54) SEED COATING METHODS AND COMPOSITIONS WITH A RYANODINE RECEPTOR BINDING AGENT

(71) Applicants: PIONEER HI-BRED INTERNATIONAL, INC., Johnson, IA (US); E.I. DU PONT DE NEMOURS AND COMPANY, Wilmington, DE (US)

(72) Inventors: David Allen Aupperle, Hockessin, DE (US); Matthew Enrico Baur, Newark, DE (US); Dantas Carneiro, JR., Santa Cruz do Sul (BR); Paula Davis, Grimes, IA (US); Sandra Mary Endicott, Norwalk, IA (US); Deborah Lynne Freerksen, Hockessin, DE (US); Daniel Kirk, Oxford (GB); Gregory Lee Lamka, Polk City, IA (US); Ivo Lersch, JR., Rio Grande do Sul (BR); Alberto Marcon, Elkton, MD (US); David Onstad, Mahomet, IL (US); Andre Aguirre Ramos, Goiania (BR); Fabio Maximiano Andrade Silva, Bairro Cascata (BR); David Accordi Tassara, Sao Paulo (BR)

(21) Appl. No.: 14/425,185

(22) PCT Filed: Aug. 29, 2013
(86) PCT No.: PCT/US2013/057308

§ 371 Date: Mar. 2, 2015

Related U.S. Application Data
(60) Provisional application No. 61/694,860, filed on Aug. 30, 2012.

(51) Int. Cl. A01N 43/56; A01N 47/32; A01N 43/78; A01N 43/36; A01N 37/22; A01N 43/90; A01N 47/20; A01N 43/88

(52) U.S. Cl. CPC A01N 43/56; A01N 47/20; A01N 47/32; A01N 43/88; A01N 43/36; A01N 37/22; A01N 43/90; A01N 43/78

(57) ABSTRACT

The present invention relates generally to the control of pests that cause damage to crop plants. The invention relates to methods and compositions for enhancing invertebrate protection of a plant or reducing the development of resistance to diamides in invertebrates comprising the use of ryanodine receptor agonists. In some embodiments, this includes methods of using mixtures of ryanodine receptor agonists with other modes of pest resistance, such as other pesticidal compounds and/or transgenic pest resistant crop plants. Optionally, biological inoculants may be used to enhance overall plant health.

### FIELD OF THE INVENTION

The present invention relates to methods for controlling invertebrate pests and managing invertebrate pest resistance in crop plants.

### BACKGROUND OF THE INVENTION

The control of invertebrate pests is extremely important in achieving high crop efficiency. Damage by invertebrate pests to agronomic crops can cause significant reduction in productivity and thereby result in increased costs to the consumer.

Invertebrates, such as Lepidoptera, annually destroy an estimated 15% of agricultural crops in the United States and other countries. Yearly, these pests cause over $100 billion dollars in crop damage in the U.S. alone. In South America, significant damage to field crops such as soybean are caused by velvet bean caterpillar (Anticarsia gemmatalis) and also by other Lepidoptera such as the fall armyworm, soybean looper and lesser corn stalk borer.

Some of this damage occurs in the soil when plant pathogens, invertebrate and other such soil borne pests attack the seed after planting. Other damage occurs after the plant foliage and above ground pests have emerged, at which time the above ground pests will significantly damage the plant foliage, thereby limiting plant yield. General descriptions of the type and mechanisms of attack of pests on agricultural crops are provided by, e.g., Metcalf (1962), in Destructive and Useful Insects, 4th ed. (McGraw-Hill Book Co., NY); and Agrios (1988), in Plant Pathology, 3d ed. (Academic Press, NY).

In an ongoing seasonal battle, farmers apply billions of gallons of synthetic pesticides to combat these pests. However, synthetic pesticides pose many problems. They are expensive, costing U.S. farmers alone almost $8 billion dollars per year. They force the emergence of insecticide-resistant pests, and they can harm the environment. Post planting applications of pesticides require passes through the field that use fossil fuels and result in soil compaction.

Because of concern about the impact of pesticides on public health and the health of the environment, significant efforts have been made to find ways to reduce the amount of chemical pesticides that are used. Recently, much of this effort has focused on the development of transgenic crops that are engineered to express toxicants derived from Bacillus thuringiensis as well as the development of seed treatment application of pesticides. While seed treatment applications are useful in the early stages of plant development, their efficacy typically drops off at about the time the above ground leaf feeding pests emerge and feed on the plant foliage.

### SUMMARY OF THE INVENTION

It has been surprisingly discovered that ryanodine receptor agonists provide extended protection to soybean plants well beyond the time period typically expected, and provides protection from above ground feeding pests well into the foliar life cycle of the soybean plants. It is predicted that these results will also apply to other legumes, and/or other deep rooted plant. Insect resistance management programs have been designed that utilize this surprising result to improve the effectiveness and durability of crop resistance to Lepidoptera and other invertebrates in soybeans and other legumes, and/or other deep rooted plants.

Compounds for use in the present invention comprise diamides, and more specifically, anthranilic diamides and/or phthalic diamides. These include a compound of formula 1 or formula 2 as provided below.

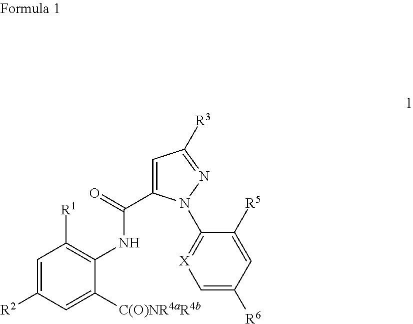

wherein

X is N, CF, CCl, CBr or CI;

R¹ is CH₃, Cl, Br or F;

R² is H, F, Cl, Br or cyano;

R³ is F, Cl, Br, C₁-C₄ haloalkyl or C₁-C₄ haloalkoxy;

R^{4a} is H, C₁-C₄ alkyl, cyclopropylmethyl or 1-cyclopropylethyl;

R^{4b} is H or CH₃;

R⁵ is H, F, Cl or Br; and

R⁶ is H, F, Cl or Br.

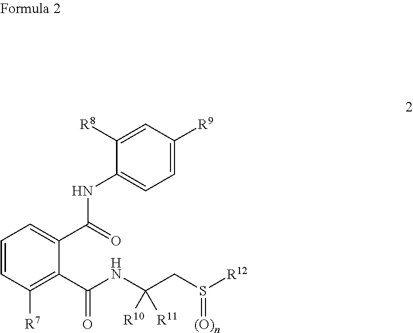

wherein
R⁷ is CH₃, Cl, Br or I;
R⁸ is CH₃ or Cl;
R⁹ is C₁-C₃ fluoroalkyl;
R¹⁰ is H or CH₃;
R¹¹ is H or CH₃;
R¹² is C₁-C₂ alkyl; and
n is 0, 1 or 2.

These compounds and mixtures comprising these compounds are more specifically disclosed and described in WO2001/070671, WO2003/015519, WO2004/067528, WO2006/007595, WO2006/068669 and U.S. Pat. No. 6,603,044, each of which is incorporated by reference herein. Specific formulations and methods of use are disclosed in WO2003/015518, WO2003/024222, WO2007/081553, WO2008/021152, WO2008/069990 and US2012/0149567, each of which is incorporated by reference herein. Other formulations of anthranilic diamides are known, such as those reported in Dinter, et. al, “Chlorantraniliprole (Rynaxypyr): A novel DuPont™ insecticide with low toxicity and low risk for honey bees (Apis mellifera) and bumble bees (Bombus terrestris) providing excellent tools for uses in integrated pest management”, Julius-Kühn-Archiv 423, 2009.

The invention relates to a method of enhancing invertebrate protection of a plant or reducing the development of resistance to diamides in invertebrates comprising the use of ryanodine receptor agonists. In some embodiments, this includes methods of using mixtures of ryanodine receptor agonists with other modes of pest resistance, such as other pesticidal compounds and/or transgenic pest resistant crop plants. Specific embodiments include the use of anthranilic diamides and/or phthalic diamides.

The invention relates to a method of controlling an invertebrate pest capable of damaging a soybean plant or for reducing the development of resistance to an anthranilic diamide and/or phthalic diamide, comprising contacting the invertebrate pest or its environment with a biologically effective amount of an anthranilic diamide and/or phthalic diamide, and optionally with at least one additional pesticidal component that does not bind to invertebrate ryanodine receptors. In some embodiments, this includes methods of using a mixture of a ryanodine receptor agonist with other modes of pest resistance, such as another pesticidal compound and/or a transgenic pest resistant crop plants.

This invention also relates to such methods wherein the invertebrate pest or its environment is contacted with a composition comprising a biologically effective amount of a compound of Formula 1 or 2, an N-oxide, or a salt thereof, and at least one additional component selected from the group consisting of surfactants, solid diluents and liquid diluents, said composition optionally further comprising a biologically effective amount of at least one additional biologically active compound or agent, provided that the methods are not methods of medical treatment of a human or animal body by therapy.

The invention also relates to a seed comprising pest resistance, wherein the seed has at least two, at least three, at least four or at least five or more layers of seed treatment, and wherein at least one layer comprises a diamide, such as an anthranilic diamide and/or phthalic diamide, with a first mode of action which comprises binding to invertebrate ryanodine receptors. The seed may comprise transgenic pest resistance. Optionally, other seed treatment pesticidal compounds may be used. In some embodiments, the additional pesticidal compounds may be present on the seed in a subsequent layer applied following the application of the first layer comprising the diamide compound.

The invention also relates to methods of farming using the surprising result, such as by reducing the number of foliar insecticide applications required during the growing the season. Thus, methods of growing an invertebrate resistant crop treating seed of said crop with a diamide compound, thereby resulting in a reduced number of foliar insecticide applications, is also an embodiment of this invention.

Additional detail regarding the disclosed invention will be provided in the following description.

### DETAILED DESCRIPTION

In the description that follows, a number of terms are used extensively. The following definitions are provided to facilitate understanding of the invention.

As used herein, the terms “comprises”, “comprising”, “includes”, “including”, “has”, “having”, “contains”, “containing”, “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components or elements, in addition to those literally disclosed, provided that these additional materials, steps, features, components or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising”, it should be readily understood that (unless otherwise stated) the description should be interpreted to also describe such an invention using the terms “consisting essentially of” or “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

As referred to in this disclosure, the term “invertebrate pest” includes arthropods, gastropods, nematodes and helminths of economic importance as pests. The term “arthropod” includes insects, mites, spiders, scorpions, centipedes, millipedes, pill bugs and symphylans. The term “gastropod” includes snails, slugs and other Stylommatophora. The term “nematode” includes members of the phylum Nematoda, such as phytophagous nematodes and helminth nematodes parasitizing animals. The term “helminth” includes all of the parasitic worms, such as roundworms (phylum Nematoda), heartworms (phylum Nematoda, class Secernentea), flukes (phylum Platyhelminthes, class Tematoda), acanthocephalans (phylum Acanthocephala), and tapeworms (phylum Platyhelminthes, class Cestoda). In the context of this disclosure “invertebrate pest control” means inhibition of invertebrate pest development (including mortality, feeding reduction, and/or mating disruption), and related expressions are defined analogously.

A “plot” is intended to mean an area where crops are planted of whatever size.

As used herein, the term “mode of action” means the biological or biochemical means by which a pest control strategy or compound inhibits pest feeding and/or increases pest mortality.

The term “transgenic pest resistant crop plant” means a plant or progeny thereof (including seeds) derived from a transformed plant cell or protoplast, wherein the plant DNA contains an introduced heterologous DNA molecule, not originally present in a native, non-transgenic plant of the same strain, that confers resistance to one or more invertebrate pests. The term refers to the original transformant and progeny of the transformant that include the heterologous DNA, including progeny produced by a sexual outcross between the transformant and another variety that includes the heterologous DNA. It is also to be understood that two different transgenic plants can also be mated to produce offspring that contain two or more independently segregating, added, heterologous genes.

As used herein, the term “soybean” means Glycine max, inclusive of the subspecies used for commercial grain production. In one embodiment, the disclosed methods are useful for managing resistance in a plot of transgenic pest resistant soybean.

As used herein, the terms “pesticide”, “pesticidal activity” and “pesticidal compound” are used synonymously to refer to activity of an organism or a substance (such as, for example, a protein or pesticide compound) that can be measured, by way of non-limiting example, via pest mortality, retardation of pest development, pest weight loss, pest repellency, reduced plant defoliation, and other behavioral and physical changes of a pest or plant after feeding and exposure for an appropriate length of time. Pests include but are not limited to invertebrate pests, insects, fungal pathogens and bacterial pathogens. In this manner, pesticidal activity often impacts at least one measurable parameter of pest fitness. For example, the pesticide may be a polypeptide to decrease or inhibit invertebrate feeding and/or to increase invertebrate mortality upon ingestion of the polypeptide. Assays for assessing pesticidal activity are well known in the art. The terms “insecticide”, “insecticidal activity” and “insecticidal compound” are used synonymously to refer to pesticide(s) with activity primarily directed towards invertebrate pests. Pesticides and insecticides suitable for use as part of the invention are well known and listed in, for example, The Pesticide Manual, 11th ed., (1997) ed. C. D. S. Tomlin (British Crop Protection Council, Farnham, Surrey, UK). When a compound is described herein, it is to be understood that the description is intended to include salt forms as well as any isomeric and/or tautomeric form that exhibits the same type of activity. The term “pesticidal” is used to refer to a toxic effect against a pest (e.g., anticarsia), and includes activity of either, or both, an externally supplied pesticide and/or an agent that is produced by the crop plants. The term “insecticidal” refers to pesticides with activity primarily directed toward invertebrate pests.

As used herein, the term “pesticidal gene” or “pesticidal polynucleotide” refers to a nucleotide sequence that encodes a polypeptide that exhibits pesticidal activity. As used herein, the terms “pesticidal polypeptide,” “pesticidal protein,” or “pesticidal toxin” is intended to mean a protein having pesticidal activity.

As used herein, the term “seed treatment” refers to the treatment of seed or propagules used for plant generation or regeneration. For soybean, treatment typically will occur pre-planting through seed coating, although depending upon the dose, timing and method of application; treatment can also occur in-furrow at planting. Pre-planting seed treatment may occur pre-sale, and additional layer of seed treatment may occur closer to the time of planting, as is sometimes the case when microbes or their spores are applied to the seed as a seed treatment coating. As used herein, seed treatment includes all seed treatments applied to the seed, regardless of whether the compounds are applied in combination or in sequence. Compounds applied in sequence result in two or more layers of seed treatment compounds being applied to the seed. Typically, but not necessarily, the uppermost layer will be allowed to fully or partially dry before the subsequent layer is applied.

As used herein, the term “transgenic” includes any cell, cell line, callus, tissue, plant part, or plant, the genotype of which has been altered by the presence of heterologous nucleic acid including those transgenics initially so altered as well as those created by sexual crosses or asexual propagation from the initial transgenic event. The term “transgenic” as used herein does not encompass the alteration of the genome (chromosomal or extra-chromosomal) by conventional plant breeding methods or by naturally occurring events such as random cross-fertilization, non-recombinant viral infection, non-recombinant bacterial transformation, non-recombinant transposition, or spontaneous mutation.

As used herein, the term “ug ai/seed” refers to micrograms of active ingredient per seed.

As used herein, the term “plant” includes reference to whole plants, plant organs (e.g., leaves, stems, roots, etc.), seeds, plant cells, plant protoplasts, plant cell tissue cultures from which plants can be regenerated, plant calli, plant clumps, and plant cells that are intact in plants or parts of plants and progeny of same. Parts of plants are to be understood within the scope of the invention to comprise, for example, plant cells, protoplasts, tissues, callus, embryos as well as flowers, pollen, ovules, seeds, branches, kernels, ears, cobs, husks, stalks, stems, fruits, leaves, roots, root tips, anthers, and the like. Grain means the mature seed produced by commercial growers intended for purposes other than growing or reproducing the species.

As used herein, the term “plant cell” includes, without limitation, cells of a plant, including without limitation cells from seeds, suspension cultures, embryos, meristematic regions, callus tissue, leaves, roots, shoots, gametophytes, sporophytes, pollen, and microspores. Regenerable plant cells are plant cells that, when isolated, may be regenerated into a complete living plant. Non-regenerable plant cells are plant cells that are not regenerated into a complete living plant. The invention described herein may be applied to non-regenerable plant cells. For example, Anticarsia may feed on plant foliage that is not capable of regeneration, especially in the environment of a plot intended for grain production, and cells macerated or ingested as a result of feeding by the invertebrate are not capable of regeneration. One aspect of the invention is the enhancement of the duration of resistance in the non-regenerable cells upon which the plant pest has fed or may feed. Another is the enhancement of the durability of the trait in those types of cells in general.

As used herein, the term “enhancing invertebrate resistance” is intended to mean that the plant has increased resistance to one or more invertebrate pests relative to a plant having a similar genetic component with the exception of the genetic modification and/or pesticidal treatments described herein. Genetically modified plants of the present invention are capable of expression of at least one insecticidal protein, such as but not limited to a Bt insecticidal protein, that protects a plant from an invertebrate pest. “Protects a plant from an invertebrate pest” is intended to mean the limiting or eliminating of invertebrate pest-related damage to a plant by, for example, inhibiting the ability of the invertebrate pest to grow, feed, and/or reproduce or by killing the invertebrate pest. As used herein, “impacting an invertebrate pest of a plant” includes, but is not limited to, deterring the invertebrate pest from feeding further on the plant, harming the invertebrate pest by, for example, inhibiting the ability of the invertebrate to grow, feed, and/or reproduce, or killing the invertebrate pest.

As used herein, the term “insecticidal protein” or “insecticidal polypeptide” is used in its broadest sense and includes, but is not limited to, a polypeptide with toxic or inhibitory effects on invertebrates, such as any member of the family of Bacillus thuringiensis proteins described herein and known in the art, and includes, for example, the vegetative insecticidal proteins and the δ-endotoxins or cry toxins. Thus, as described herein, invertebrate resistance can be conferred to an organism by introducing a nucleotide sequence encoding an insecticidal protein or applying an insecticidal substance, which includes, but is not limited to, an insecticidal protein, to an organism (e.g., a plant or plant part thereof). A “Bt Soybean” refers to a soybean plant expressing an insecticidal compound whose sequence was derived in whole or in part from a Bacillus thuringiensis protein.

Those skilled in the art will recognize that not all compounds are equally effective against all pests. Compounds of the embodiments display activity against invertebrate pests, which may include economically important agronomic, forest, greenhouse, nursery, ornamentals, food and fiber, public and animal health, domestic and commercial structure, household, and stored product pests.

A “pesticidal agent” is a pesticide that is supplied externally to the crop plant, or a seed of the crop plant. The term “insecticidal agent” has the same meaning as pesticidal agent, except its use is intended for those instances wherein the pesticidal agent is primarily directed toward invertebrate pests.

As used herein, the term “reducing the development of resistance” means that when viewed on a population basis over time (years), the frequency of resistance genes that accumulate in the population will be at a lower frequency than if steps had not be taken to minimize the spread of such resistance genes throughout the population.

The term “diamide” means a compound comprising two amido groups.

The term “ryanodine receptor” refers to a class of intracellular calcium channels in invertebrate cells, which typically show high affinity to the plant alkaloid ryanodine as one of many compounds that will bind to the receptor. Antagonistic compounds will reduce or block the activity of the calcium channel. Agonist or activator compounds will enhance the activity of the calcium channel.

The following table will assist the reader with the acronyms for the invertebrate pests. Note that the table lists the most common pests that are the target of pest resistance strategies, but the invention is not limited to only these pests.

TABLE 1
Invertebrate Pests

| Acronym | Common Name | Scientific Name |
|---|---|---|
| BCW | Black cutworm | Agrotis ipsilon (Hufnagel) |
| BAW | Beet armyworm | Spodoptera exigua (Hübner) |
| | Axil borer | Crocidosema (= Epinotia) aporema |
| | | (Walsingham) |
| CL | Cabbage looper | Trichoplusia ni (Hübner) |
| CEW | Corn earworm | Helicoverpa zea (Boddie) |
| CSB | Common stalk borer | Papaipema nebris (Guenée) |
| SAW | Southern armyworm | Spodoptera eridania (Stoll) |
| FAW | Fall armyworm | Spodoptera frugiperda (JE Smith) |
| VAW | Velvet armyworm | Spodoptera latisfascia (Walker) |
| GCW | Green cloverworm | Hypena scabs (Fabricius) |
| SLF | Soybean leaffolder | Omiodes indicata (Fabricius) |
| LCB | Lesser cornstalk borer | Elasmopalpus lignosellus (Zeller) |
| SBL | Soybean looper | Chrysodeixis (= Pseudoplusia) |
| | | includens (Walker) |
| SFL | Sunflower looper | Rachiplusia nu (Guenée) |
| TBW | Tobacco budworm | Heliothis virescens (Fabricius) |
| VBC | Velvetbean caterpillar | Anticarsia gemmatalis (Hübner) |
| YSA | Yellowstriped armyworm | Spodoptera ornithogalli (Guenée) |

### Lepidoptera

Larvae of the order Lepidoptera include, but are not limited to, armyworms, cutworms, loopers, and heliothines in the family Noctuidae, Spodoptera frugiperda J E Smith (fall armyworm); S. exigua Hübner (beet armyworm); S. litura Fabricius (tobacco cutworm, cluster caterpillar); Mamestra configurata Walker (bertha armyworm); M. brassicae Linnaeus (cabbage moth); Agrotis ipsilon Huihagel (black cutworm); A. orthogonia Morrison (western cutworm); A. subterranea Fabricius (granulate cutworm); Alabama argillacea Hübner (cotton leaf worm); Trichoplusia ni Hübner (cabbage looper); Pseudoplusia includens Walker (soybean looper); Anticarsia gemmatalis (velvetbean caterpillar); Hypena scabs Fabricius (green cloverworm); Heliothis virescens Fabricius (tobacco budworm); Pseudaletia unipuncta Haworth (armyworm); Athetis mindara Barnes and Mcdunnough (rough skinned cutworm); Euxoa messoria Harris (darksided cutworm); Earias insulana Boisduval (spiny bollworm); E. vittella Fabricius (spotted bollworm); Helicoverpa armigera Hübner (American bollworm); H. zea Boddie (corn earworm or cotton bollworm); Melanchra picta Harris (zebra caterpillar); Egira (Xylomyges) curialis Grote (citrus cutworm); borers, casebearers, webworms, coneworms, and skeletonizers from the family Pyralidae, Ostrinia nubilalis Hübner (European corn borer); Amyelois transitella Walker (naval orangeworm); Anagasta kuehniella Zeller (Mediterranean flour moth); Cadra cautella Walker (almond moth); Chilo suppressalis Walker (rice stem borer); C. partellus, (sorghum borer); Corcyra cephalonica Stainton (rice moth); Crambus caliginosellus Clemens (corn root webworm); C. teterrellus Zincken (bluegrass webworm); Cnaphalocrocis medinalis Guenée (rice leaf roller); Desmia funeralis Hübner (grape leaffolder); Diaphania hyalinata Linnaeus (melon worm); D. nitidalis Stoll (pickleworm); Diatraea grandiosella Dyar (southwestern corn borer), D. saccharalis Fabricius (surgarcane borer); Eoreuma loftini Dyar (Mexican rice borer); Ephestia elutella Hübner (tobacco (cacao) moth); Galleria mellonella Linnaeus (greater wax moth); Herpetogramma licarsisalis Walker (sod webworm); Homoeosoma electellum Hulst (sunflower moth); Elasmopalpus lignosellus Zeller (lesser cornstalk borer); Achroia grisella Fabricius (lesser wax moth); Loxostege sticticalis Linnaeus (beet webworm); Orthaga thyrisalis Walker (tea tree web moth); Maruca testulalis Geyer (bean pod borer); Plodia interpunctella Hübner (Indian meal moth); Udea rubigalis Guenée (celery leaftier); and leafrollers, budworms, seed worms, and fruit worms in the family Tortricidae, Acleris gloverana Walsingham (Western blackheaded budworm); A. variana Fernald (Eastern blackheaded budworm); Archips argyrospila Walker (fruit tree leaf roller); A. rosana Linnaeus (European leaf roller); and other Archips species, Adoxophyes orana Fischer von Rösslerstamm (summer fruit tortrix moth); Cochylis hospes Walsingham (banded sunflower moth); Cydia latiferreana Walsingham (filbertworm); C. pomonella Linnaeus (coding moth); Platynota flavedana Clemens (variegated leafroller); P. stultana Walsingham (omnivorous leafroller); Lobesia botrana Denis & Schiffermüller (European grape vine moth); Spilonota ocellana Denis & Schiffermüller (eyespotted bud moth); Endopiza viteana Clemens (grape berry moth); Eupoecilia ambiguella Hübner (vine moth); Bonagota salubricola Meyrick (Brazilian apple leafroller); Grapholita molesta Busck (oriental fruit moth); Suleima helianthana Riley (sunflower bud moth); Argyrotaenia spp.; Choristoneura spp.

Selected other agronomic pests in the order Lepidoptera include, but are not limited to, Alsophila pometaria Harris (fall cankerworm); Anarsia lineatella Zeller (peach twig borer); Anisota senatoria J. E. Smith (orange striped oakworm); Antheraea pernyi Guérin-Méneville (Chinese Oak Silkmoth); Bombyx mori Linnaeus (Silkworm); Bucculatrix thurberiella Busck (cotton leaf perforator); Colias eurytheme Boisduval (alfalfa caterpillar); Datana integerrima Grote & Robinson (walnut caterpillar); Dendrolimus sibiricus Tschetwerikov (Siberian silk moth), Ennomos subsignaria Hübner (elm spanworm); Erannis tiliaria Harris (linden looper); Euproctis chrysorrhoea Linnaeus (browntail moth); Harrisina americana Guérin-Méneville (grapeleaf skeletonizer); Hemileuca oliviae Cockrell (range caterpillar); Hyphantria cunea Drury (fall webworm); Keiferia lycopersicella Walsingham (tomato pinworm); Lambdina fiscellaria fiscellaria Hulst (Eastern hemlock looper); L. fiscellaria lugubrosa Hulst (Western hemlock looper); Leucoma salicis Linnaeus (satin moth); Lymantria dispar Linnaeus (gypsy moth); Manduca quinquemaculata Haworth (five spotted hawk moth, tomato hornworm); M. sexta Haworth (tomato hornworm, tobacco hornworm); Operophtera brumata Linnaeus (winter moth); Paleacrita vernata Peck (spring cankerworm); Papilio cresphontes Cramer (giant swallowtail, orange dog); Phryganidia californica Packard (California oakworm); Phyllocnistis citrella Stainton (citrus leafminer); Phyllonorycter blancardella Fabricius (spotted tentiform leafminer); Pieris brassicae Linnaeus (large white butterfly); P. rapae Linnaeus (small white butterfly); P. napi Linnaeus (green veined white butterfly); Platyptilia carduidactyla Riley (artichoke plume moth); Plutella xylostella Linnaeus (diamondback moth); Pectinophora gossypiella Saunders (pink bollworm); Pontia protodice Boisduval & Leconte (Southern cabbageworm); Sabulodes aegrotata Guenée (omnivorous looper); Schizura concinna J. E. Smith (red humped caterpillar); Sitotroga cerealella Olivier (Angoumois grain moth); Thaumetopoea pityocampa Schiffermuller (pine processionary caterpillar); Tineola bisselliella Hummel (webbing clothesmoth); Tuta absoluta Meyrick (tomato leafminer); Yponomeuta padella Linnaeus (ermine moth); Heliothis subflexa Guenée; Malacosoma spp. and Orgyia spp.

### Example 1

### 120 ug ai/Seed Dose

Soybean seeds were treated with chlorantraniliprole at rates of 120 ug ai/seed. The seeds were sown into soil bed fields with a size of 6 meters in length and 4 rows of 40 cm in width. Leaf samples were collected at the 3rd to the 7th soybean trifoliate growth stage and brought to the laboratory. Laboratory-field leaf bio-assay (LBF) was performed for each soybean growth stage using velvetbean caterpillar (VBC) (Anticarsia gemmatalis) exposing the leaves to 2nd instar larvae stage. Each treatment group was replicated 4 times, and results (Table 2) are expressed as % larval mortality. At 43 days after planting, the VBC larval mortality rate was 88%.

TABLE 2
Mortality of velvetbean caterpillar (VBC) larvae exposed to soybeans
plants grown from seeds treated with chlorantraniliprole.

| | Rate (ug | Soybean leaf | Days after | % VBC larval |
|---|---|---|---|---|
| Active | ai/seed) | stage | planting (DAP) | mortality |
| Chlorantraniliprole | 120 | 3rd trifoliate | 25 | 100 |
| | | 4th trifoliate | 29 | 94 |
| | | 5th trifoliate | 36 | 91 |
| | | 7th trifoliate | 43 | 88 |

### Example 2

### 100 ug ai/Seed Dose (Area 1)

Soybean seeds were treated with chlorantraniliprole at rate of 100 ug ai/seed. The seeds were sown into soil bed fields (area 1) with a size of 8 meters by 8 meters in size, with an area of 64 m2. Plots were replicated 4 times. Evaluation was based on the total number of velvetbean caterpillar (VBC) (Anticarsia gemmatalis) larvae per meter at 37 to 63 days after planting (DAP), and converted to % larvae count reduction compared to the untreated (Table 3). 50 days after planting, the VBC larvae reduction was still 73%, and after 63 days had activity at 35%.

TABLE 3
Percent velvetbean caterpillar (VBC) larvae reduction compared to
untreated checks when exposed to soybean plants grown from
seeds treated with chlorantraniliprole

| | Rate | Days after | % VBC |
|---|---|---|---|
| Active | (ug ai/seed) | planting (DAP) | larvae reduction |
| Chlorantraniliprole | 100 | 37 | 20 |
| | | 50 | 73 |
| | | 63 | 35 |

### Example 3

### 100 ai Dose (Area 2)

Soybean seeds were treated with chlorantraniliprole at rate of 100 ug ai/seed. The seeds were sown into soil bed fields (area 2) with a size of 8 meters by 8 meters in size, with an area of 64 m2. Plots were replicated 4 times. Evaluation was based on the total number of velvetbean caterpillar (VBC) (Anticarsia gemmatalis) larvae per meter at 37 to 63 days after planting (DAP), and converted to % larvae count reduction compared to the untreated. Surprisingly, the larvae reduction increased between 50 to 63 days after planting, with a larvae reduction at 43% after 63 days (Table 4).

TABLE 4
Percent velvetbean caterpillar (VBC) larvae reduction compared to
untreated checks when exposed to soybean plants grown from
seeds treated with chlorantraniliprole

| | Rate | Days after | % VBC |
|---|---|---|---|
| Active | (ug ai/seed) | planting (DAP) | larvae reduction |
| Chlorantraniliprole | 100 | 37 | 25 |
| | | 50 | 20 |
| | | 63 | 43 |

### Example 4

### Model

In light of the surprising extended duration of efficacy observed in soybeans with seed treatment application of ryanodine receptor binding agents, novel strategies for invertebrate resistant management were modeled and designed that are anticipated to result in an increase in insecticidal activity on a plant and in a reduction of invertebrate development of resistance to pesticidal agents. Modeling occurred through computer simulation based on the data of Example 1 provided above.

Model Parameters and Assumptions

The components of the modeling system were as follows: (1) a seed treatment formulation comprising a ryanodine receptor binding agent known as chlorantraniliprole, (2) a foliar insecticide, where the foliar insecticides were assumed to cause mortality of stinkbugs and Lepidoptera but which mortality did not select for resistance to the foliar insecticide, (3) either one or two transgenic soybean Bt traits used that selected for resistance, and (4) the presence of one or more velvetbean caterpillar (Anticarsia gemmatalis). Foliar insecticides were included in the model because stinkbug management to protect developing pods and seeds is standard practice in Brazil, and some of the foliar sprays may have activity against Lepidoptera.

The model tracked changes in genotype frequencies. It was assumed that the invertebrate had one major gene for resistance to each plant protectant, and that each locus was autosomal and di-allelic, with no linkage between loci. It was further assumed that mutations did not occur after the start of the simulation, there were no fitness costs due to resistance, no cross resistance among resistance genes, and that survival to multiple toxins was the product of the survival proportions to each toxin alone.

A Brazilian landscape was used for the model. The landscape was represented by two patches of soybean: block refuge of soybeans without insecticide and blocks of soybean with insecticides. Insecticides are either chlorantraniliprole seed treatment formulation, single trait transgenic Bt soybean or chlorantraniliprole formulation treated transgenic Bt soybean.

Literature indicated that the Anticarsia gemmatalis egg through pupae period lasts approximately 25 days. Data also suggest that typical cultivars of soybean start yellowing and lose leaves about 125 days after germination. Thus, the model assumed that there were five discrete insect generations per soybean growing season of equal length, and that foliar insecticides would affect the last three insect generations in blocks of refuge.

The Anticarsia gemmatalis moths are strong fliers, so dispersal is expected amongst fields and plots. The model assumed that mating is random across all patches and all soybean fields, and further assumed that eggs are uniformly distributed across the region, such that the probability of larvae being in each patch is equal to the proportion of the landscape composed of each patch.

The model assumed that the dose of Bt in the soybean plant does not decline between generations within a year. Survival of heterozygotes is based on expression of resistance as recessive or near recessive. Three curves for survival over time are used for homozygous susceptible (SS), heterozygous with one resistance gene (RS) and homozygous recessive with two resistance genes (RR). Multiplicative survival rates for each toxin/gene were assumed. The model calculated a function of survival of neonates or larvae as a function of dose on day of infestation and another function for dose as a function of time since soybean germination. The toxicity of the seed treatment is based on an exponential decay of dose from start of invertebrate generation 1, exp[−r(G−1)] where G is generation and r is decay rate. The following function was used to predict survival based on dose at start of generation.

Survival (dose)=1/(1+ê(b+m·ln(dose)))

The model further assumed that 0.001 and 0.05 are the survival rates for homozygous susceptible (SS) larvae in generations one and two. With incompletely recessive resistance to the chlorantraniliprole seed treatment formulation, the model assumed 0.01 and 0.36 are the associated survival rates for heterozygotes (RS). Survival of homozygous resistant (RR) larvae is always 1. Therefore, the model assumed b=6.907 for SS and b=4.5951 for RS and b=−1000 for RR individuals. We used m=8 for all simulations and genotypes. We evaluated a decay rate, r=−0.5, for the chlorantraniliprole seed treatment formulation in soybean based on Example 1 results (Table 2). In the final three insect generations, the seed treatment kills 25%, 1%, and 0% of the SS and 3%, 0%, and 0% of RS.

Initial Conditions and Model Analysis

The model started with each resistance allele in Hardy-Weinberg equilibrium and with a frequency of 0.001. Initial frequency of each genotype was determined assuming independent loci.

The model then recorded when the population exceeded 50% R allele frequency for each resistance allele and evaluated 1%, 5%, or 20% block refuge for all insecticides including the seed treatment.

Baseline Simulations for Soybean Products

As noted above, the model criterion for durability was allele frequency exceeding 50% for all resistance alleles. The following tables report the years (and generations for years less than 15) during which the allele frequency was modeled to exceed 50%. Table 5 presents the results for the simulations with Bt soybean. As expected, larger refuges prolong durability. Also if the invertebrate has resistance alleles that are completely recessive, evolution is slower. The results for the chlorantraniliprole seed treatment formulation by itself are presented in Table 6.

TABLE 5
Time required for resistance allele frequency to exceed 50% when
Bt soybean is deployed by itself, under assumed relative fitnesses*.

| Refuge | Dominance* | Years | Generations |
|---|---|---|---|
| 1% | incomp. rec. | 2 | 8 |
| 5% | incomp. rec. | 5 | 22 |
| 20% | incomp. rec. | 17 | — |
| 1% | recessive | 4 | 18 |
| 5% | recessive | 13 | 62 |
| 20% | recessive | 53 | — |

*Heterozygote survival is 0.01 for incomplete recessive resistance and 0.003 for recessive condition.

TABLE 6
Time required for resistance allele frequency to exceed 50% when the
chlorantraniliprole seed treatment formulation is deployed by itself,
under assumed generation-dependent relative fitness.

| Refuge | Years | Generations |
|---|---|---|
| 1% | 3 | 11 |
| 5% | 4 | 16 |
| 20% | 7 | 31 |

Simulations Demonstrating Value of Seed Treatment in Prolonging Durability of Bt Trait

In all scenarios explored, combinations of Bt soybean plus the chlorantraniliprole seed treatment formulation (Table 7) were more durable than deploying either Bt soybean alone (Table 5) or the chlorantraniliprole seed treatment formulation alone (Table 6). Another option to consider is sequential deployment where the second product is deployed only after resistance gene frequency for first product exceeds 50%. Deploying combinations of Bt soybean and the chlorantraniliprole seed treatment formulation is expected to delay time to resistance versus sequential deployment of each product particularly at higher refuge levels and when resistance to Bt is fully recessive (Table 7).

TABLE 7
Years required for both resistance-allele frequencies to exceed 50% when
Bt soybean is deployed in combination with a Chlorantraniliprole
seed treatment formulation, as compared to deploying
each product sequentially.

| Refuge | Dominance* | Combination | Sequential |
|---|---|---|---|
| 1% | incomp. rec. | 5 | 5 |
| 5% | incomp. rec. | 11 | 9 |
| 20% | incomp. rec. | 36 | 24 |
| 1% | recessive | 9 | 7 |
| 5% | recessive | 25 | 17 |
| 20% | recessive | 100 | 60 |

*For Bt soybean, heterozygote survival is 0.01 for incompletely recessive resistance and 0.003 for recessive condition.

As shown by the model, benefits can be obtained by combining the diamide compound with other insecticides with different modes of action, such as, but not limited to:

(1) Chlorantraniliprole 625 g/L (25 ug ai/seed) with Fipronil 250 g/L (50 ug ai/seed), Pyraclostrobin 25 g/L (5 ug ai/seed), and thiophanate-methyl 225 g/L (45 ug ai/seed); (2) Chlorantraniliprole 625 g/L (25 ug ai/seed) with Thiamethoxam 350 g/L (87.5 ug ai/seed), Fludioxonil 25 g/L (2.5 ug ai/seed), Metalaxyl-M 20 g/L (2 ug ai/seed), and TBZ 150 g/L (15 ug ai/seed);

(3) Chlorantraniliprole 625 g/L (25 ug ai/seed) with Thiamethoxam 350 g/L (87.5 ug ai/seed), Abamectin 500 g/L (50 ug ai/seed), Fludioxonil 25 g/L (2.5 ug ai/seed), Metalaxyl-M 20 g/L (2 ug ai/seed), and TBZ 150 g/L (15 ug ai/seed); and

(4) Chlorantraniliprole 625 g/L (25 ug ai/seed) with Chlothianidin 600 g/L (60 ug ai/seed).

Additionally, the same methods may be employed for multiple pests in the same plot. As multiple invertebrate control mechanisms may be used in connection with a single type of seed, it is therefore possible for the disclosed methods to be used against multiple target pests.

While the invention is described predominantly using examples of pests affecting soybean, the invention may work on other crops where the extended effect of the diamide is tested and observed. Such crops may include other legumes and crops with root structures and vascular systems such that the extended efficacy of the diamide will function in a manner similar to how it functions in soybeans.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

That which is claimed:

1. A method of enhancing invertebrate protection of a soybean plant, or reducing the development of resistance to diamides in an invertebrate population, comprising treating soybean seed with at least two pesticidal compounds, wherein at least one pesticidal compound is a diamide insecticide that binds to invertebrate ryanodine receptors present in an amount sufficient to confer invertebrate protection to the above ground tissue of the soybean plant for at least 45 days following germination of said seed, and wherein at least one pesticidal compound does not bind to invertebrate ryanodine receptors and is present in an amount sufficient to confer invertebrate protection to the soybean plant.

2. The method of claim 1, wherein the invertebrate is a species of Lepidoptera.

3. The method of claim 1, wherein the invertebrate is fall armyworm, velvet bean caterpillar, soybean looper or lesser corn stalk borer.

4. The method of claim 1, wherein the invertebrate is Anticarsia.

5. The method of claim 1, wherein the diamide insecticide comprises an anthranilic diamide or a phthalic diamide.

6. The method of claim 1, wherein the diamide insecticide is an anthranilic diamide.

7. The method of claim 1, wherein the diamide insecticide is selected from the group consisting of chlorantraniliprole and cyantraniliprole.

8. The method of claim 5, wherein the diamide is part of a composition comprising by weight based on the total weight of the composition: (a) from about 9 to about 91% of one or more diamide insecticides; and (b) from about 9 to about 91% of an acrylate/methacrylate-based star copolymer component having a water solubility of at least about 5% by weight at 20° C., a hydrophilic-lipophilic balance value of at least about 3, and an average molecular weight ranging from about 1,500 to about 150,000 daltons; wherein the ratio of component (b) to component (a) is about 1:10 to about 10:1 by weight.

9. The method of claim 1, wherein the rate of application of the diamide insecticide is 25 ug ai/seed, 50 ug ai/seed, 100 ug ai/seed, or greater than 100 ug ai/seed.

10. The method of claim 1, wherein the rate of application of the diamide insecticide is 50 ug ai/seed or less.

11. The method of claim 1, wherein the pesticidal compound that does not bind to invertebrate ryanodine receptors is a transgenic insecticidal polypeptide.

12. The method of claim 11, wherein the insecticidal polypeptide is a Bacillus thuringiensis polypeptide.

13. The method of claim 1, wherein the pesticidal compound that does not bind to invertebrate ryanodine receptors is selected from the group consisting of an insecticide, an acaricide, a nematicide, a fungicide, a bactericide, or a combination thereof.

14. The method of claim 1, wherein the pesticidal compound that does not bind to invertebrate ryanodine receptors is a biological inoculant with pesticidal activity.

15. The method of claim 1, wherein said pesticidal compound that does not bind to invertebrate ryanodine receptors comprises one or more compounds selected from the group consisting of abamectin, acetamiprid, avermectin, clothianidin, dinotefuran, fipronil, fludioxonil, imidacloprid, indoxacarb, lambda-cyhalothrin, metalaxyl, metalaxyl-m, pyraclostrobin, pymetrozine, spinosad, TBZ, thiacloprid, thiamethoxam and thiophanate-methyl.

16. The method of claim 1, wherein the method comprises obtaining a dried treated seed comprising a diamide insecticide, and subsequently treating said seed with a pesticidal compound that does not bind to invertebrate ryanodine receptors.

17. The method of claim 1, wherein the method comprises the steps of treating a seed with a diamide insecticide, drying said seed, and subsequently treating said seed with a pesticidal compound that does not bind to invertebrate ryanodine receptors.

18. A method of enhancing invertebrate protection of a soybean plant or reducing the development of resistance to diamide insecticides in invertebrate populations comprising:
(a) Obtaining a crop seed comprising a first pesticidal resistance mode of action that does not consist of binding ryanodine receptors, and
(b) Treating said seed with a seed treatment comprising a diamide insecticide with a second mode of action which comprises binding to invertebrate ryanodine receptors, wherein the effective amount of said diamide insecticide is sufficient to confer invertebrate protection to the soybean plant for at least 45 days following germination of said seed.

19. The method of claim 18, wherein the invertebrate is a species of Lepidoptera.

20. The method of claim 18, wherein the invertebrate is fall armyworm, velvet bean caterpillar, soybean looper or lesser corn stalk borer.

21. The method of claim 18, wherein the invertebrate is Anticarsia.

22. The method of claim 18, wherein the diamide insecticide comprises an anthranilic diamide or a phthalic diamide.

23. The method of claim 18, wherein the diamide insecticide is an anthranilic diamide.

24. The method of claim 18, wherein the diamide insecticide is selected from the group consisting of chlorantraniliprole and cyantraniliprole.

25. The method of claim 22, wherein the diamide is part of a composition comprising by weight based on the total weight of the composition: (a) from about 9 to about 91% of one or more diamide insecticides; and (b) from about 9 to about 91% of an acrylate/methacrylate-based star copolymer component having a water solubility of at least about 5% by weight at 20° C., a hydrophilic-lipophilic balance value of at least about 3, and an average molecular weight ranging from about 1,500 to about 150,000 daltons; wherein the ratio of component (b) to component (a) is about 1:10 to about 10:1 by weight.

26. The method of claim 18, wherein the rate of application of the diamide insecticide is 25 ug ai/seed, 50 ug ai/seed, 100 ug ai/seed, or greater than 100 ug ai/seed.

27. The method of claim 21, wherein the rate of application of the diamide insecticide is 50 ai/seed or less.

28. The method of claim 18, wherein the first pesticidal resistance mode of action that does not consist of binding ryanodine receptors is a transgenic insecticidal polypeptide.

29. The method of claim 28, wherein the insecticidal polypeptide is a Bacillus thuringiensis polypeptide.

30. The method of claim 18, wherein the first pesticidal resistance mode of action that does not consist of binding ryanodine receptors is selected from the group consisting of an insecticide, an acaricide, a nematicide, a fungicide, a bactericide, or a combination thereof.

31. The method of claim 18, wherein the first pesticidal resistance mode of action that does not consist of binding ryanodine receptors comprises one or more compounds selected from the group consisting of abamectin, acetamiprid, avermectin, clothianidin, dinotefuran, fipronil, fludioxonil, imidacloprid, indoxacarb, lambda-cyhalothrin, metalaxyl, metalaxyl-m, pyraclostrobin, pymetrozine, spinosad, TBZ, thiacloprid, thiamethoxam and thiophanate-methyl.

32. Seed comprising two or more layers of seed treatment, wherein said first layer comprises a diamide insecticide which binds to invertebrate ryanodine receptors, and said second layer comprises a pesticidal compound that does not bind to invertebrate ryanodine receptors.

33. The seed of claim 32, wherein the diamide insecticide comprises an anthranilic diamide or a phthalic diamide.

34. The seed of claim 32, wherein the diamide insecticide is an anthranilic diamide.

35. The seed of claim 33, wherein the diamide insecticide is part of a composition comprising by weight based on the total weight of the composition: (a) from about 9 to about 91% of one or more diamide insecticides; and (b) from about 9 to about 91% of an acrylate/methacrylate-based star copolymer component having a water solubility of at least about 5% by weight at 20° C., a hydrophilic-lipophilic balance value of at least about 3, and an average molecular weight ranging from about 1,500 to about 150,000 daltons; wherein the ratio of component (b) to component (a) is about 1:10 to about 10:1 by weight.

36. The seed of claim 32, wherein the rate of application of the diamide insecticide is 25 ug ai/seed, 50 ug ai/seed, 100 ug ai/seed, or greater than 100 ug ai/seed.

37. The seed of claim 32, wherein the rate of application of the diamide insecticide is 50 ug ai/seed or less.

38. The seed of claim 32, wherein the pesticidal compound that does not bind to invertebrate ryanodine receptors is selected from the group consisting of an insecticide, an acaricide, a nematicide, a fungicide, a bactericide, or a combination thereof.

39. The seed of claim 32, wherein the pesticidal compound that does not bind to invertebrate ryanodine receptors is a biological inoculant with pesticidal activity.

40. The seed of claim 32, wherein said pesticidal compound that does not bind to invertebrate ryanodine receptors comprises one or more compounds selected from the group consisting of abamectin, acetamiprid, avermectin, clothianidin, dinotefuran, fipronil, fludioxonil, imidacloprid, indoxacarb, lambda-cyhalothrin, metalaxyl, metalaxyl-m, pyraclostrobin, pymetrozine, spinosad, TBZ, thiacloprid, thiamethoxam and thiophanate-methyl.
